(19) United States
(12) Patent Application Publication
(10) Pub. No.: US 2005/0012829 A1
(43) Pub. Date: Jan. 20, 2005

(54) Resolution selector for image capturing system

(76) Inventors: Atsushi Tashiro, Washington Township, NJ (US); Kunio Takagi, Valhalla, NY (US)

Correspondence Address: BAKER & BOTTS, 30 ROCKEFELLER PLAZA, NEW YORK, NY, 10112, US

(21) Appl. No.: 10/729,603

(22) Filed: Dec. 5, 2003

Related U.S. Application Data
(60) Provisional application No. 60/488,082, filed on Jul. 17, 2003.

(51) Int. Cl. H04N 5/262

(52) U.S. Cl. 348/231.99

(57) ABSTRACT

The present invention provides a selector on the body of a digital camera that permits a user to select a resolution for a JPEG image that is generated from a RAW image and is embedded in the RAW image's data structure. The user may select from available embedded JPEG resolutions of, for example, 1440×960, 2304×1536, or 3024×2016. The present invention also provides a display on the digital camera that shows the user which of the available JPEG resolutions currently selected.

### I. CROSS REFERENCE TO RELATED APPLICATIONS

This application claims the benefit of, and incorporates by reference in its entirety, U.S. Provisional Application No. 60/488,082, which was filed on Jul. 17, 2003.

### II. BACKGROUND OF INVENTION

This invention relates to a device for selecting a resolution for a digital image generated using a digital camera.

Digital cameras use special-purpose light sensors, such as charge-coupled devices (“CCDs”) and complementary metal-oxide (“CMOS”) sensors, to directly sample the light reflected from an object that is being photographed. These sensors convert the light from the object into electrical charges, which are in turn converted into a matrix of adjacent digital pixel values called a bitmap. The bitmap is the raw data that the camera uses to define the digital image.

Bitmap files can be quite large, especially in professional quality digital cameras which are capable of producing digital images comprising as many as tens of millions of pixels. As a result, digital cameras typically store compressed versions of the bitmap file. There are several well-known image compression formats: some are lossy and others lossless. The image formats most commonly used by digital cameras are the Joint Photographic Experts Group (“JPEG”) format, the Tagged Image File Format (“TIFF”), and the various proprietary RAW formats.

Most digital cameras produce images in JPEG format. JPEG compression is lossy, however, and inevitably deteriorates the quality of the image to some degree. Thus, JPEG images are not acceptable for users who will be printing the image rather than simply viewing it on a computer screen. Higher-end digital cameras produce both JPEG and TIFF images. TIFF compression is lossless, which results in a high quality image that is more suitable than JPEG for printing and other professional purposes. However, the disadvantage to TIFFs is that they are very large files. They use up precious memory space, and can take a relatively long time to output from the camera.

Some digital cameras offer users the option of storing image files in one of several proprietary RAW formats. RAW files comprise bitmap data that was taken directly from the camera sensor without having been first processed. Because RAW compression is lossless, it produces very high quality images. At the same time, RAW files are significantly smaller than TIFFs.

Generally, to view a RAW image, a user must download the RAW file from the digital camera to a desktop computer such as a PC. Then, on the PC, the user must use specialized software to convert the RAW image into a TIFF or a JPEG. Only then may the image be displayed.

One notable problem with this process is that it is time consuming to convert a RAW file into a TIFF or JPEG, and can be especially time consuming if the user of the digital camera wants to view a series of RAW images. To solve this problem, certain digital camera manufacturers have created a RAW data file that includes an embedded JPEG version of the RAW image. The embedded JPEG data allows the user to open downloaded RAW images as a JPEG immediately, without first having to go through the time-consuming conversion process.

However, in these known RAW-with-embedded-JPEG formats, the resolution of the embedded JPEG images is generally fixed at, e.g., 1440×960 pixels. At such fixed resolutions, the quality of the image is sufficient to produce only 5×7 inch prints, which are often too small for the user's purposes. For larger print sizes, the user must still resort to the time-consuming process of converting the RAW data into a higher resolution JPEG or TIFF file.

Thus, there is a need in the art for granting the user of a digital camera the flexibility to quickly view RAW images of different resolutions while avoiding the time-consuming file conversion process.

### III. SUMMARY OF THE INVENTION

This and other needs in the art are addressed by the present invention, which provides a selector on the body of the digital camera that permits a user to select a resolution for a JPEG image that is generated from a RAW image and is embedded in the RAW image's data structure. In an exemplary embodiment of the present invention, the user may select from available embedded JPEG resolutions of 1440×960, 2304×1536, or 3024×2016. The present invention also provides a display on the digital camera that indicates to the user which of the available JPEG resolution is currently selected.

### IV. BRIEF DESCRIPTION OF THE DRAWINGS

FIG. 1 is a block diagram depicting a digital camera including a RAW-JPEG resolution selector and a display;

FIG. 2 is a diagram depicting the structure of a RAW data file including embedded JPEG data with selectable resolution;

FIG. 3 is a photograph of a digital camera including a selectable-JPEG resolution selector and a display;

FIG. 4 is a photograph depicting a magnified view of a selectable-JPEG resolution selector and a display; and

FIG. 5 is a diagram depicting three display icons, each of which corresponds to a different selectable-JPEG resolution.

### V. DESCRIPTION OF THE INVENTION

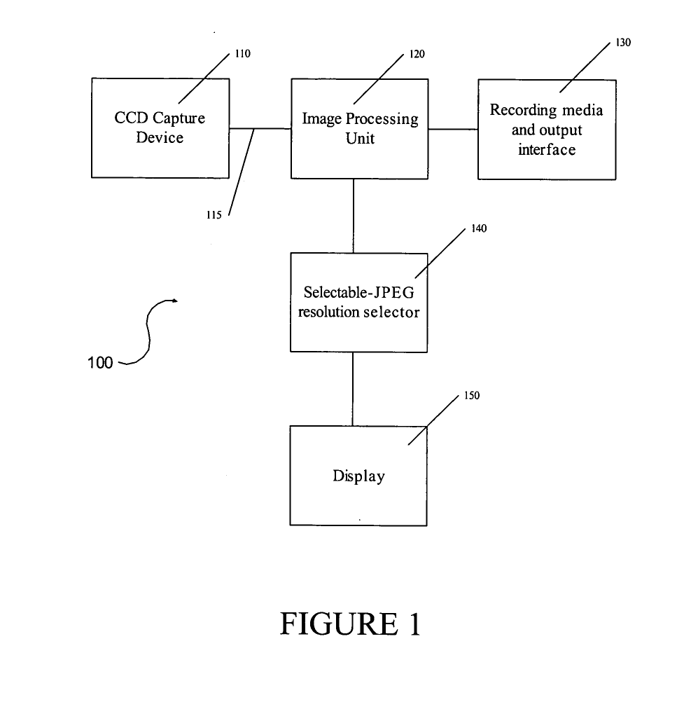

FIG. 1 is a block diagram depicting a digital camera 100 in accordance with an exemplary embodiment of the present invention. The digital camera 100 includes a light sensor capture device such as, for example, a CCD capture device 110. Those of skill in the art will appreciate that a CMOS device, or any other suitable light sensor capture device, could be used instead of a CCD capture device.

The CCD capture device 110 directly samples light reflected from an object that is to be photographed. The sampled light from the object is converted into electrical charges by the CCD capture device 110. These electrical charges are, in turn, converted into a matrix of adjacent digital pixel values called bitmap data 115. The bitmap data 115 is raw data generated by the CCD capture device 110 that defines the digital image.

If the photographs are to be stored as RAW images, the bitmap data 115 is sent directly from the CCD capture device 110 to the image processing unit 120. The image processing unit 120 converts the bitmap data 115 into a RAW image.

The RAW image is converted by the image processing unit 120 into a compressed file using a lossy compression algorithm, for example, JPEG. It will be appreciated by those of skill in the art that this invention is not limited to JPEG compressed image files. As an alternative, any suitable lossy compression algorithm may be used in place of JPEG.

The image processing unit 120 generates a low-resolution JPEG image from the RAW image. The low-resolution JPEG is suitable for generating thumbnail images for display on a computer screen. The image processing unit 120 also generates a selectable-resolution JPEG image from the RAW image.

The selectable-resolution JPEG image is generated from the RAW image at a resolution that was previously selected by the user from a plurality of available resolutions. The user makes a selection using the selectable-JPEG resolution selector 140. The available JPEG resolutions are displayed on a display 150. The display 150, which is located on the body of the digital camera 100, also indicates to the user which of the available JPEG resolutions is currently selected.

The low-resolution JPEG image and the selectable-resolution JPEG image are both embedded by the image processing unit 120 into the RAW image's data structure. The user outputs the RAW image comprising the embedded JPEG data from the digital camera 100 via the external interface 130 to a recording medium, an external personal computer, or any other image-displaying device. The user may then view the selectable-resolution JPEG image at the resolution previously selected. The user thus may view the RAW image as a JPEG at the resolution selected while avoiding the time-consuming process of first converting the RAW image into a JPEG or TIFF image having the desired resolution.

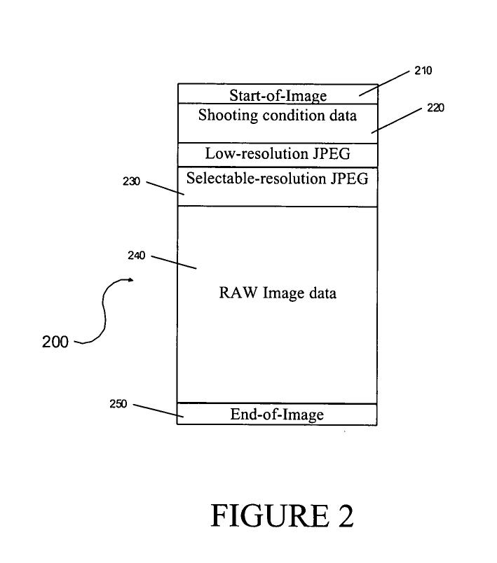

FIG. 2 is a diagram depicting the data structure 200 of a RAW image in accordance with an exemplary embodiment of the present invention. The RAW image's data structure includes a start-of-image marker 210, shooting condition data 220, low-resolution JPEG data 230, selectable-resolution data 240, RAW image data 250, and an end-of-image marker 260.

The start-of-image marker 210 marks the beginning of the RAW image's data structure. The shooting condition data 220 may include information about such things as the lighting conditions and aperature settings when the picture was shot. The low-resolution JPEG data 220 includes a low resolution JPEG image generated from the RAW image that is suitable for thumbnail images for display on a computer screen. The selectable-resolution JPEG 240 is JPEG data that was generated from the RAW image by the image processing unit 120 having the resolution selected by the user using the selectable-JPEG resolution selector 140. The RAW image data 250 is the data defining the original RAW image. And the end-of-image marker 260 marks the end of the RAW image's data structure.

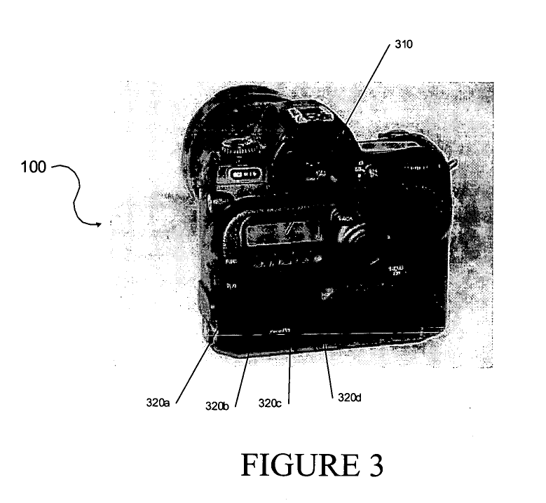

FIG. 3 is a photograph of the rear portion of the digital camera 100, in accordance with an exemplary embodiment of the present invention. Selector buttons 320a-d are used to input commands to the digital camera's 100 operating software. At least one of these selector buttons 320a-d may be used to input the desired resolution for the embedded selectable-resolution JPEG image.

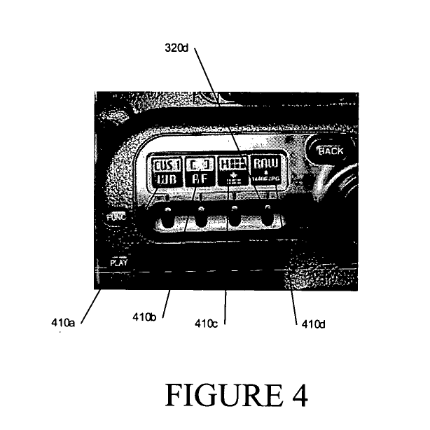

FIG. 4 is a photograph depicting a magnified view of the display 150 and the selector buttons 320a-d, in accordance with an exemplary embodiment of the present invention. The display 150 may display a plurality of icons 410a-d. If the RAW format has been selected for the images, at least one of the icons 410a-d—for example, icon 410d—will indicate which of the plurality of selectable-JPEG resolutions is currently selected. Icon 410d, for example, reads “RAW & 1440EJPG,” which indicates to the user that the photograph will be stored in RAW format, with the embedded selectable-JPEG image currently having a selected resolution of 1440×960.

By pushing selector button 320d, the user may change the resolution that the embedded selectable-JPEG image will have. The user's selection is transmitted to the image processing unit 120, as was previously described. The image of the icon 410d will change with each push of the selector button 320d, indicating to the user which selectable-JPEG resolution is currently set.

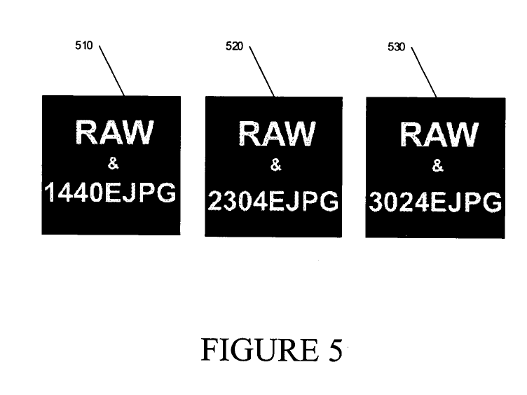

FIG. 5 is a diagram depicting three icon-images 510, 520 and 530, each corresponding to a different selectable-JPEG resolution, in accordance with an exemplary embodiment of the present invention. Icon-image 510 will appear on display 150 when a selectable-JPEG resolution of 1440×960 has been selected by the user. Likewise, icon-image 520 will appear on display 150 when a selectable-JPEG resolution of 2304×1536 has been selected, and icon-image 530 will appear on display 150 when a selectable-JPEG resolution of 3024×2016 has been selected.

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are understood to be within the scope of the appended claims.

1. A digital camera comprising:
a light sensor capture device that samples light from an object to be photographed and converts the sampled light into unprocessed bitmap data;
a memory that stores the unprocessed bitmap data in a raw image file;
an image processor, wherein said image processor converts the unprocessed bitmap data into a first compressed image having a first resolution, converts the unprocessed bitmap data into a second compressed image having a second selectable resolution, and embeds the first compressed image and the second compressed image into the raw image file; and
a selector that facilitates selection of the second selectable resolution from one or more selectable resolution values.

2. The digital camera of claim 1, further comprising a display operable to show the one or more resolution values selectable for the second selectable resolution.

3. The digital camera of claim 2 wherein said display is operable to show which of the resolution values for the second selectable resolution is currently selected.

4. The digital camera of claim 3 wherein said light sensor capture device comprises a charge-coupled device.

5. The digital camera of claim 4 wherein the first and second compressed images comprise JPEG images.

6. The digital camera of claim 5 wherein the raw image file is in RAW format.

7. The digital camera of claim 6 wherein the first resolution is suitable for generating thumbnail images on the display.

8. The digital camera of claim 7 wherein the values for the second selectable resolution include 1440×960, 2304×1536, and 3024×2016.

9. The digital camera of claim 8 wherein said display is operable to show one or more icons, each icon corresponding to at least one of the one or more selectable resolution values

10. A method for generating a digital image from an object photographed by a digital camera, comprising:
sampling light from the object;
converting the sampled light into unprocessed bitmap data and storing the unprocessed bitmap data in a raw image file;
converting the unprocessed bitmap data into a first compressed image having a first resolution;
selecting a resolution value from one or more selectable resolution values;
converting the unprocessed bitmap data into a second compressed image having a second resolution that corresponds to the resolution selected in the selecting step; and
embedding the first compressed image and the second compressed image into the raw image file that includes the unprocessed bitmap data.

11. The method of claim 10, further comprising displaying one or more selectable resolution values for selection in the selecting step.

12. The method of claim 11 further comprising displaying which of the selectable resolution values is currently selected.

13. The method of claim 12 wherein said sampling step includes sampling light from the object using a charge-coupled device.

14. The method of claim 13 wherein the first and second compressed images are JPEG images.

15. The method of claim 14 wherein the raw image file is in RAW format.

16. The method of claim 15 wherein the first resolution is suitable for generating thumbnail images on the display.

17. The method of claim 16 wherein the values for the second selectable resolution include 1440×960, 2304×1536, and 3024×2016.

18. The method of claim 17, further comprising displaying one or more icons, each icon corresponding to at least one of the one or more selectable resolution values.
